(19) United States
(12) Patent Application Publication
(10) Pub. No.: US 2012/0032542 A1
(43) Pub. Date: Feb. 9, 2012

(54) WATER-PROOF DUST-PROOF AND SALTY-MIST-PROOF COOLING FAN

(75) Inventors: CHING-TANG LIU, HSINCHU COUNTY (TW); TAI-YING LU, HSINCHU COUNTY (TW); TUNG-SHENG YI, HSINCHU COUNTY (TW)

(73) Assignee: ROTECHNIC COMPANY LIMITED, HSINCHU COUNTY (TW)

(21) Appl. No.: 12/850,779

(22) Filed: Aug. 5, 2010

(51) Int. Cl. H02K 5/10

(52) U.S. Cl. 310/88

(57) ABSTRACT

A water-proof dust-proof and salty-mist proof cooling fan, comprising: a fan frame, which is provided with a fixing round stage inside, and a fixing sleeve is disposed in a center of said fixing round stage; a ring-shaped U slot is provided in a bottom end surface of said round stage, such that a sealing circle is provided in said ring-shaped U slot; a water-proof cover body, fixedly connected to said fan frame through said sealing circle; and a fan-blade hub, where an inverse cone-shaped fixing table is provided protruding from a cavity center of said fan-blade hub, and said fixing table is connected to a main axis. Said round stage is a blind hole, with its open end provided at a bottom portion of said fan frame, such that said round stage, said sealing circle, and said cover body together form a tight-sealing enclosure.

### BACKGROUND OF THE INVENTION

1. Field of the Invention

The present invention relates to a cooling fan, and in particular to a water-proof dust-proof and salty-mist-proof cooling fan.

2. The Prior Arts

A cooling fan is mainly composed of rotors, stators, rolling bodies, and circuit boards. Along with the ever expanding fields of cooling fan applications, from CPU, server, power supply, to the communication equipment, and outdoor machine stations, the environment the cooling fan is utilized is getting increasingly severe. Usually, in a damp and salty mist environment, the stator and circuit board are under no protection, thus the silicon steel sheet of the stator tends to get rusty and be corroded, and the elements on the circuit board are liable to get short-circuited and burned out, such that the cooling fan can not function normally.

Presently, a cooling fan is made by two kinds of methods: a vacuum film platting method, and glue pouring method.

In a vacuum film plating method, the entire stators and circuit board elements are plated with a layer of film, so as to achieve water-proof effect, Yet, since this layer of film fits tightly on the surface of an object, and in the film plating process, the stress in this layer of film tends to damage elements on a circuit board, so that the cooling fan is not able to function normally. In addition, since this layer of film is thin, so in a salty mist environment, it is liable to be ionized, hereby causing the short-circuit and burning out of the electronic elements, therefore, the cooling fan can not function normally.

In the glue pouring method, a mold is utilized. Firstly, installing the stators and circuit board onto the outer frame of a cooling fan, next putting this part of fan into a mode, then pouring in glue, finally taking this part out from the mold after curing of the glue. The main purpose of this process is to fill the inner space of the fan and around the stator and circuit board with glue, so as to achieve the effect of water proof. However, in this way, the layer of glue formed inside the fan is rather thick, and it wraps around the electronic elements, thus adversely affecting the heat dissipation of the electronic elements, and causing the burning out of the electronic elements and the malfunction of the cooling fan. Moreover, in the cooling and curing process of the glue, the stress in the glue will damage the elements on a circuit board, so that the cooling fan is not able to function normally.

Therefore, the design and manufacturing of the cooling fan at present is not satisfactory, and it has much room for improvements.

### SUMMARY OF THE INVENTION

In view of the problems and shortcomings of the prior art, the present invention provides a cooling fan, which is capable of water-proof, dust-proof, and salty-mist proof.

A major objective of the present invention is to provide a water-proof dust-proof and salty-mist proof cooling fan, comprising: a fan frame, which is provided with a fixing round stage inside, and a fixing sleeve is disposed in the center of the fixing round stage; a ring-shaped U slot is provided on the bottom end surface of the fan frame, such that a sealing circle is provided in the ring-shaped U slot; a water proof cover body, which is fixedly connected onto the fan frame through the sealing circle; and a fan-blade hub, in which an inverse cone-shaped fixing table is disposed protruding and extending from the cavity center of the fan-blade hub, and the fixing table is connected to a main axis. The round stage is a blind hole, with its open end provided at the bottom portion of the fan frame, such that the round stage, sealing circle, and the cover body together form a tight-sealing enclosure, which is provided with stators and circuit board elements inside.

In one aspect of the present invention, four snap-fit slots spaced apart are provided on an end surface of the round stage, and four snap-fit hooks corresponding to the four snap-fit slots are spaced apart and protruding from the side wall of the water-proof cover body, such that the cooperation of the respective snap-fit slots and snap-fit hooks enable the water-proof cover body to be installed securely on the round stage. A cylinder body is provided protruding and extending from the center of the water-proof cover body in the same direction of the snap-fit hook, such that the cylinder body directly sleeved onto the fixing sleeve at the center of the round stage.

In another aspect of the present invention, a lateral tube is provided on a side wall of the water-proof cover body, and a sleeve is sleeved around the outer surface of the lateral tube, so that the lead wires of the elements on the circuit board can be led out from the lateral tube in the sleeve. On the other end of the sleeve is provided with a water-sealing plug, that is used to block the gap between the sleeve and the lead wires, so as to ensure the tight sealing of the tight-sealing enclosure.

In a further aspect of the present invention, bearings are provided in the fixing sleeve at the center of the round stage, so that the bearings are connected to the main axis at the center of the fan-blade hub.

In yet another aspect of the present invention, a sealing circle is disposed protruding downward from the top face of the cavity of the fan-blade hub, and a plurality of evenly distributed dust-removing blades protruding and extending from the outer perimeter of the sealing circle, such that the sealing circle is hooked inversely on the fixing sleeve, hereby forming an inverse “U” shape labyrinth passage incooperation with the fixing table.

Summing up the above, the cooling fan of the present invention has the following advantages: the technology of placing the stators and the circuit board elements in tight-sealing enclosure replaces the vacuum film plating method and glue pouring method of the prior art, hereby providing effective protection for the stators and the circuit board elements, in achieving the purpose of water-proof, dust-proof, and salty-mist-proof of the cooling fan; the tightly fit cooperation of the snap-fit hooks and the snap-fit slots is utilized to achieve tight sealing and easy installation; the formation of a structure such that lead wires can be led to outside from the lateral tube in the sleeve, thus facilitating tight-sealing tests of the tight-sealing enclosure and ensuring quality of cooling fan; and moreover, a water sealing plug is provided on one end of the sleeve, to enhance the air-tightness of the tight-sealing enclosure and its operational performance, so as to avoid the inferior tight sealing of the tight-sealing enclosure due to the lead wires connecting to the outside. For the bearing portion, since one end of the sleeve for receiving bearing is sealed off by a water-proof cover body, and the other end of the sleeve is formed into a non-contact tight-seal structure by the dust-removing blades of the fan-blade hub and the “U” shape labyrinth passage, so that it can effectively prevent the entry of dust and water, regardless of whether the fan is in operation or not. In addition, the advantages of non-contact tight-seal design are that, its operation is frictionless without having to consume excessive energy and generate heat, hereby ensuring the quality of operation of the cooling fan, and prolonging the service life of the cooling fan.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed description of the present invention to be made later are described briefly as follows, in which:

FIG. 1 is an exploded view of a water-proof dust-proof and salty-mist-proof cooling fan according to the present invention;

FIG. 2 is a cross section view of a water-proof dust-proof and salty-mist-proof cooling fan according to the present invention; and

FIG. 3 is a top view of a water-proof dust-proof and salty-mist-proof cooling fan according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, a detailed description of the present invention is given through real embodiments together with the attached drawings.

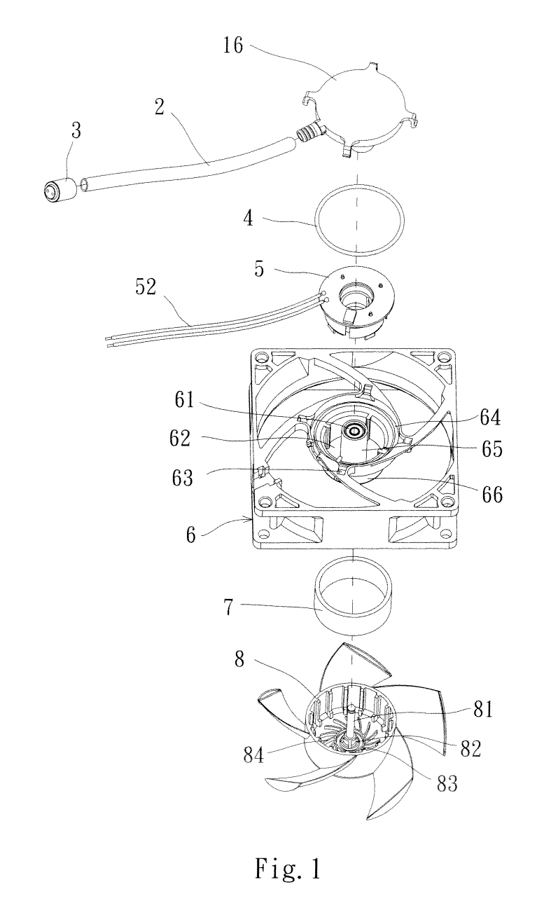

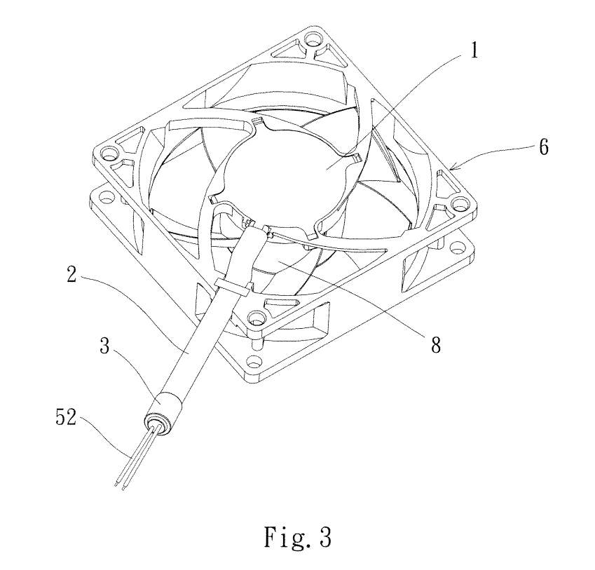

Firstly, refer to FIGS. 1-3 for an exploded view, cross section view, and top view of water-proof dust-proof and salty-mist-proof cooling fan according to the present invention respectively. As shown in FIGS. 1-3, the water-proof dust-proof and salty-mist proof cooling fan of the present invention comprises: a fan frame 6, which is provided with a fixing round stage 66 inside, and a fixing sleeve 65 is disposed at the center of the fixing round stage 66, inside the fixing sleeve 65 is provided with bearings 61; a blind hole 62, provided between the fixing round stage 66 and a fixing sleeve 65, and stators and circuit board elements 5 are disposed in the blind hole 62; four snap-fit slots 63 spaced apart are provided on an end surface of the round stage 66, and ring-shaped U slot 64 is provided on the end surface of the round stage 66, inside the ring-shaped U slot 64 is provided with a sealing circle 4; a water-proof cover body 1, where four snap-fit hooks 11 corresponding to the four snap-fit slots 63 are spaced apart and protruding from the side wall of the water-proof cover body 1, such that the cooperation of the respective snap-fit slots 63 and snap-fit hooks 11 enable the water-proof cover body 1 to be installed securely on the round stage 66 through the sealing circle 4; a cylinder body 13, protruding and extending from inside the water-proof cover body 1 in the same direction of the snap-fit hook 11, such that the cylinder body 13 is sleeved directly onto the fixing sleeve 65 at the center of the round stage 66 under the cooperation of the snap-fit hooks 11 and snap-fit slots 63; a lateral tube 12, provided on a side wall of the water-proof cover body 1, and a sleeve 2 is sleeved around the outer surface of the lateral tube 12, so that the lead wires 52 of the circuit board elements Scan be led out from the lateral tube 12 in the sleeve 2, on the other end of the sleeve 2 is provided with a water-sealing plug 3, that is used to seal the gap between the sleeve 2 and the lead wires 52; a fan-blade hub 8, from the center of its cavity is disposed extending an inverse cone-shaped fixing table 82, which is connected to a main axis 81, such that the main axis 81 is connected to and cooperate with the bearings 61; and a ring-shaped permanent magnet 7, provided in the fan-blade hub 8 for providing a permanent magnetic field.

When installing the cooling fan, all it has to do is to put the circuit board elements 5, permanent magnet 7, fan blades 8, and bearings 61 in their proper and corresponding places; next, putting the sealing circle 4 into the ring-shaped U slot 64, and putting the lead wires 52 through the lateral tube 12 on the side wall of the water-proof cover body 1, then placing the water-proof cover body 1 and hooking it onto the round stage 66; subsequently, passing the lead wires 52 through the lateral tube 2, so that the sleeve 2 is sleeved onto the lateral tube 12; and finally, sleeving the water-sealing plug 3 around the sleeve 2. Moreover, water-proof sealing glue can be applied on the interface of the water-proof cover body 1 and the sealing circle 4, and also between the cylinder body 13 and the fixing sleeve 65, so as to ensure the tight-seal effect. Furthermore, upon completion of the process mentioned above, sealing glue can be applied on the rim at the intersection of the water-proof cover body 1 and the round stage 66, hereby further enhancing tight-seal effect.

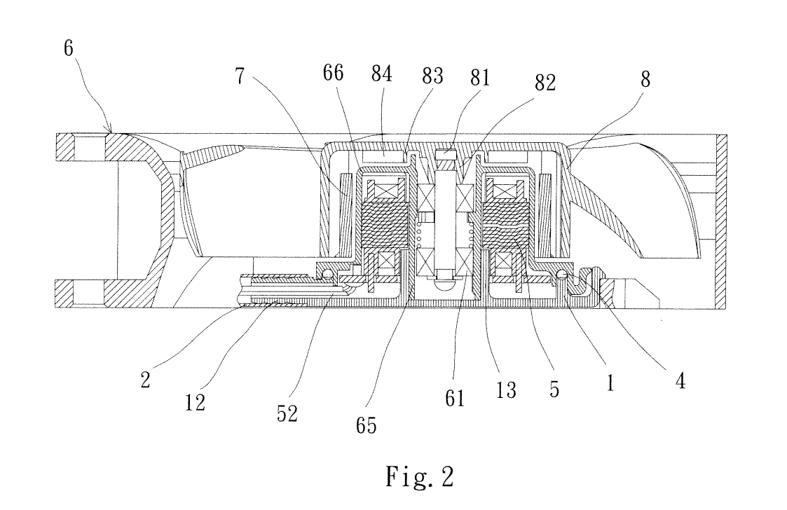

In application of the cooling fan, as shown in FIG. 2, the sealing circle 83 inside the fan blade hub 8 is hooked inversely onto the fixing sleeve 65, thus forming an inverse “U” shaped labyrinth passage in cooperation with a fixing table 82. The design of labyrinth passage is such that, the cooling fan is capable of preventing outside particles from getting into the fixing sleeve 65, regardless of whether the fan is in operation, hereby protecting the normal operations of the bearings 61. A plurality of evenly distributed dust-removing blades 84 extending from the outer perimeter of the sealing circle 83 in the fan blade hub 8, such that in operation. the centrifugal force will prevent the outside particles from getting into the cooling fan, thus protecting the normal operations of bearings 61 in the fixing sleeve 65.

According to the present invention, other varied embodiments are possible, such as the water-proof cover body and fan frame can be made into an integral body, or they can be independent accessories, with the round stage made into an independent part, so that the stator and circuit board elements are assembled onto the fan frame, then the round stage is fixed onto the outer frame to achieve tight seal. Therefore, this varied embodiment naturally falls into the claimed scope of the present invention.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water-proof dust-proof and salty-mist proof cooling fan, comprising:
a fan frame, which is provided with a fixing round stage inside, and a fixing sleeve is disposed in a center of said fixing round stage, and a ring-shaped U slot is provided on an end surface of said round stage, inside said ring-shaped U slot is provided with a sealing circle; a water-proof cover body, installed securely on said fan frame through said sealing circle; a fan-blade hub, and from said center of its cavity is provided extending an inverse cone-shaped fixing table, which is connected to a main axis, said round stage is a blind hole, with its open end located at a bottom of said fan frame, such that said round stage, said sealing circle, and said water-proof cover body together form a tight-sealing enclosure with stators and said circuit board elements disposed therein.

2. The water-proof dust-proof and salty-mist proof cooling fan as claimed in claim 1, wherein four snap-fit slots are spaced apart and are provided on an end surface of said round stage, and four snap-fit hooks corresponding to said snap-fit slots are spaced apart and protruding from a side wall of said water-proof cover body, cooperation of said respective snap-fit slots and said snap-fit hooks enable said water-proof cover body to be installed securely on said round stage.

3. The water-proof dust-proof and salty-mist proof cooling fan as claimed in claim I, wherein a lateral tube is provided on said side wall of said water-proof cover body, and a sleeve is sleeved around an outer surface of said lateral tube, so that lead wires of elements on said circuit board can be led out from said lateral tube in said sleeve, other end of said sleeve is provided with a water-sealing plug, used to block a gap between said sleeve and said lead wires, so as to ensure air-tightness of said tight-sealing enclosure.

4. The water-proof dust-proof and salty-mist proof cooling fan as claimed in claim 1, wherein a cylinder body is provided protruding and extending from a center of said water-proof cover body in a same direction of said snap-fit hook, such that said cylinder body is sleeved directly onto said fixing sleeve at said center of said round stage.

5. The water-proof dust-proof and salty-mist proof cooling fan as claimed in claim 1, wherein bearings are provided in said fixing sleeve at said center of said round stage, so that said bearings are connected to said main axis at said center of said fan-blade hub.

6. The water-proof dust-proof and salty-mist proof cooling fan as claimed in claim 1, wherein a sealing ring is provided protruding downward from a top face of cavity of said fan-blade hub, and a plurality of evenly distributed dust-removing blades are disposed protruding and extending from a surface of an outer perimeter of said sealing ring, such that said sealing ring is hooked inversely on said fixing sleeve, hereby forming an inverse “U” shape labyrinth passage in cooperation with a fixing table.
